(19) United States
(12) Patent Application Publication
(10) Pub. No.: US 2025/0319930 A1
(43) Pub. Date: Oct. 16, 2025

(54) Work Vehicle

(71) Applicant: Kubota Corporation, Osaka-shi (JP)

(72) Inventors: Shinya Tabata, Osaka (JP); Seigi Aratake, Osaka (JP); Kohta Nakao, Osaka (JP)

(21) Appl. No.: 18/967,134

(22) Filed: Dec. 3, 2024

(30) Foreign Application Priority Data
Apr. 11, 2024 (JP) 2024-064251

(51) Int. Cl. B62D 25/14; B60R 21/00; B60R 21/13

(52) U.S. Cl. CPC B62D 25/14; B60R 21/13; B60R 2021/0018; B60R 2021/137

(57) ABSTRACT

A work vehicle includes a dash panel having a front portion and an upper panel disposed forward of the dash panel and having a back portion, the front portion being over the back portion with a gap present between a front end of the front portion, and a coupler and facing forward from the front end.

### CROSS-REFERENCE TO RELATED APPLICATION

This application claims priority to Japanese Patent Application No. 2024-064251 filed Apr. 11, 2024, the disclosure of which is hereby incorporated by reference in its entirety.

### BACKGROUND OF THE INVENTION

### Field of the Invention

The present invention relates to a work vehicle including a dash panel.

### Description of Related Art

A work vehicle may, as disclosed in Japanese Unexamined Patent Application Publication, Tokukai, No. 2019-14466, include a dash panel disposed forward of the driver's seat and the passenger's seat and provided with, for example, a steering wheel.

Such a work vehicle may further include an upper panel disposed forward of the dash panel and having a back portion coupled to a front portion of the dash panel with use of a coupler.

A dash panel for a work vehicle is relatively large and is usually molded of synthetic resin. Molding a dash panel may cause its front portion to have slight vertical curves along the lateral direction, resulting in a dash panel with a wavy front portion. The dash panel of a work vehicle may also have a wavy front portion as a result of long-term exposure to sunlight as the user uses the work vehicle.

Such a wavy front portion may be coupled to a back portion of the upper panel with decreased strength.

### SUMMARY OF INVENTION

The present invention has an object of providing a work vehicle including a dash panel and an upper panel, the dash panel having a front portion coupled to a back portion of the upper panel with strength ensured for an extended period of time.

A work vehicle according to the present invention includes: a body; a travel device attached to and supporting the body; a driver's seat on the body; a passenger's seat on the body and lateral to the driver's seat; a dash panel disposed forward of the driver's seat and the passenger's seat and having a front portion; an upper panel disposed forward of the dash panel and having a back portion; and a coupler attached to the front portion and the back portion and coupling the front portion to the back portion, the front portion being over the back portion with a gap present between a front end of the front portion and the coupler and facing forward from the front end.

The above work vehicle includes a dash panel disposed forward of the driver's seat and the passenger's seat and having a front portion and an upper panel disposed forward of the dash panel and having a back portion, the front portion being over the back portion. The above work vehicle also includes a coupler attached to the front portion and the back portion and coupling the front portion to the back portion.

The front portion being over the back portion provides a preferable design at the front portion and its vicinity.

With the above configuration, the front portion has a front end separated from the coupler by a gap facing forward from the front end.

If the front portion becomes wavy before or after the coupler is attached thereto, the gap accommodates the waves as long as the waves are sized within the gap.

As a result, the waves do not greatly affect the attachment of the coupler for coupling the front portion to the back portion.

If the front portion becomes wavy after the coupler is attached thereto, the gap accommodates the waves, thereby preventing the waves from easily affecting the connection by the coupler.

With the above configuration, the gap accommodates the waves at the front portion of the dash panel. This allows the front portion to be coupled to a back portion of the upper panel with strength ensured for an extended period of time, and also provides a preferable design at the front portion and its vicinity.

The work vehicle may preferably be further configured such that the dash panel and the upper panel each extend from a right section of the body to a left section of the body, and the gap extends along an entire width of each of the dash panel and the upper panel.

The above work vehicle is configured such that the dash panel and the upper panel each extend from the right section of the body to the left section of the body and that the gap extends along the entire width of each of the dash panel and the upper panel. This allows the gap to accommodate the waves at the front portion over a large distance.

This allows the front portion to be coupled to the back portion with strength reliably ensured for an extended period of time, and provides a more preferable design at the front portion and its vicinity.

The work vehicle may preferably further include: an upper lateral frame member disposed forward of the dash panel, extending laterally, and coupled to a right section of the body and a left section of the body, wherein the upper panel is coupled to the upper lateral frame member.

The above work vehicle includes an upper lateral frame member extending laterally and coupled to the right section of the body and the left section of the body, the upper panel being coupled to the upper lateral frame member. This allows the upper panel to be held sufficiently firmly, and also allows the dash panel, which is coupled to a back portion of the upper panel, to be held sufficiently firmly.

The work vehicle may preferably further include: a lower lateral frame member disposed below the upper lateral frame member, extending laterally, and coupled to the right section of the body and the left section of the body, wherein the dash panel has a lower portion coupled to the lower lateral frame member.

The above work vehicle includes a lower lateral frame member extending laterally and coupled to the right section of the body and the left section of the body, the dash panel having a lower portion coupled to the lower lateral frame member. This allows the lower portion of the dash panel to be held sufficiently firmly, and also reliably allows the dash panel to be held sufficiently firmly.

The work vehicle may preferably be further configured such that the dash panel has a right portion coupled to the right section of the body and a left portion coupled to the left section of the body.

The above work vehicle is configured such that the dash panel has a right portion coupled to the right section of the body and a left portion coupled to the left section of the body. This reliably allows the dash panel to be held sufficiently firmly.

The work vehicle may preferably be further configured such that the body includes: a floor frame at a lower portion of the body; and a roll-over protective structure frame coupled to the floor frame and covering the driver's seat and the passenger's seat, the upper lateral frame member and the lower lateral frame member are each coupled to a right section of the roll-over protective structure frame and a left section of the roll-over protective structure frame, and the dash panel has a right portion coupled to the right section of the roll-over protective structure frame and a left portion coupled to the left section of the roll-over protective structure frame.

A work vehicle may be configured such that the body includes a floor frame at a lower portion of the body and a sufficiently firm roll-over protective structure frame coupled to the floor frame and covering the driver's seat and the passenger's seat.

The above work vehicle is configured such that the right and left sections of the roll-over protective structure frame correspond respectively to the right and left sections of the body, the upper lateral frame member and the lower lateral frame member are each coupled to a right section of the roll-over protective structure frame and a left section of the roll-over protective structure frame, and the dash panel has a right portion coupled to the right section of the roll-over protective structure frame and a left portion coupled to the left section of the roll-over protective structure frame.

This allows (i) the upper panel to be coupled to the roll-over protective structure frame with the upper lateral frame member in-between, (ii) the front portion of the dash panel to be coupled to the roll-over protective structure frame with the upper panel and the upper lateral frame member in-between, (iii) the lower portion of the dash panel to be coupled to the roll-over protective structure frame with the lower lateral frame member in-between, and (iv) the right and left portions of the dash panel to be coupled to the roll-over protective structure frame. This reliably allows the upper panel to be held sufficiently firmly, and also reliably allows the dash panel to be held sufficiently firmly.

### BRIEF DESCRIPTION OF THE DRAWINGS

FIG. 1 is a left side view of a work vehicle.

FIG. 2 is a plan view of a dash panel and an upper panel as well as their surroundings.

FIG. 3 is a rear view of a dash panel and its surroundings.

FIG. 4 is a rear view of an upper lateral frame member and a lower lateral frame member as well as their surroundings.

FIG. 5 is a cross-sectional left side view of a dash panel and an upper panel as well as their surroundings.

### DESCRIPTION OF THE INVENTION

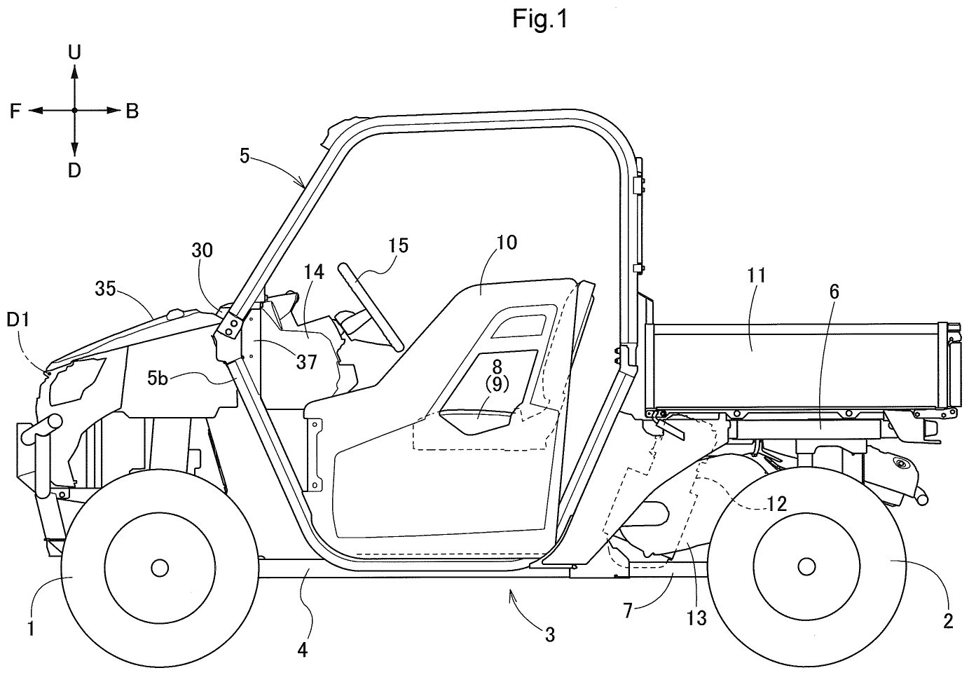

FIGS. 1 to 5 illustrate a utility vehicle as an example work vehicle. FIGS. 1 to 5 show arrow F to indicate the forward direction, arrow B to indicate the backward direction, arrow U to indicate the upward direction, arrow D to indicate the downward direction, arrow L to indicate the leftward direction, and arrow R to indicate the rightward direction.

### Overall Configuration of Work Vehicle

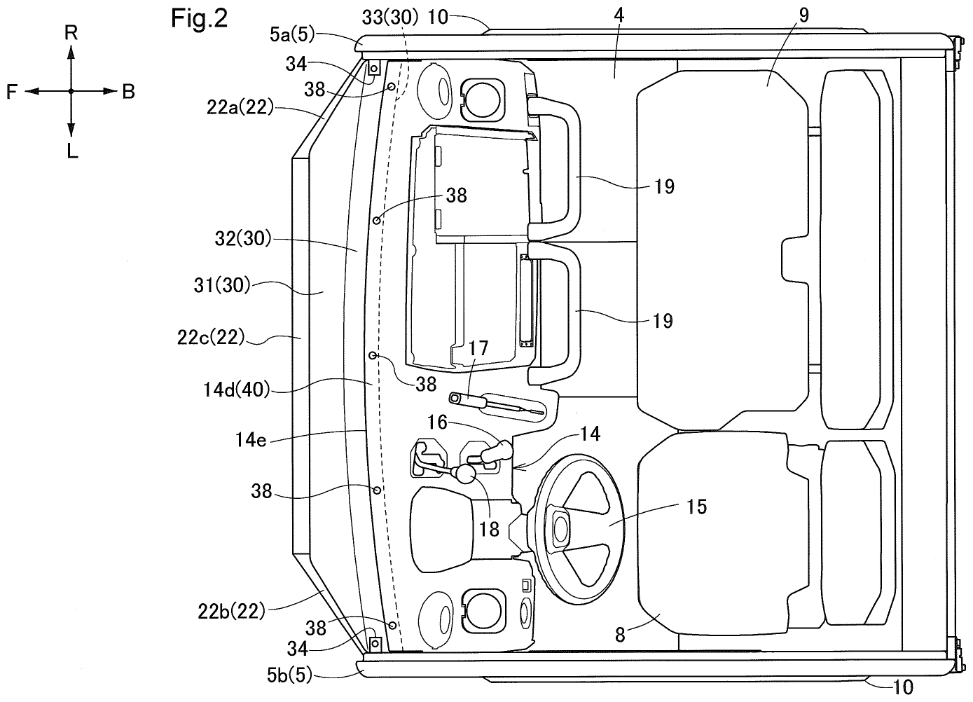

As illustrated in FIGS. 1 and 2, the work vehicle includes a body 3, a pair of right and left front wheels 1 (corresponding to the “travel device”) at a front portion of the body 3, and a pair of right and left rear wheels 2 (corresponding to the “travel device” recited in the claims) at a back portion of the body 3 such that the front and rear wheels 1 and 2 support the body 3. The body 3 includes a floor frame 4, a roll-over protective structure (ROPS) frame 5, a back frame 6, and a lower frame 7.

The floor frame 4 is at a lower portion of the body 3. The work vehicle includes a driver's seat 8 and a passenger's seat 9 arranged laterally on the floor frame 4. The ROPS frame 5 is coupled to the floor frame 4 in such a manner as to cover the driver's seat 8 and the passenger's seat 9.

The work vehicle includes a pair of right and left doors 10 attached respectively to a right ROPS frame section 5a and left ROPS frame section 5b of the ROPS frame 5 in such a manner as to be openable and closable. The back frame 6 and the lower frame 7 are each coupled to a back portion of the ROPS frame 5 and extend backward. The work vehicle includes a carrier box 11 on the back frame 6. The right and left ROPS frame sections 5a and 5b may be regarded respectively as a right section 5a and left section 5b of the body 3.

### Travel Power Transmission System

As illustrated in FIG. 1, the work vehicle includes an engine 12, a continuously variable transmission device 13, and a transmission case (not illustrated in the drawings) all disposed on the lower frame 7 as well as the rear wheels 2. The transmission case contains an auxiliary transmission device (not illustrated in the drawings), a rear-wheel differential device (not illustrated in the drawings), and a front-wheel power transmission device (not illustrated in the drawings). The auxiliary transmission device is a gear-based transmission device capable of shifting to two forward gears and one rearward gear.

The engine 12 transmits motive power to the continuously variable transmission device 13, which varies the motive power and transmits the resulting motive power to the auxiliary transmission device, which further varies the motive power and transmits the resulting motive power to the rear-wheel differential device, which transmits the motive power to the rear wheels 2. The auxiliary transmission device also transmits motive power through the front-wheel power transmission device, which serves as a branch from a position between the auxiliary transmission device and the rear-wheel differential device, to the front wheels 1.

Operating the front-wheel power transmission device for four-wheel drive causes the auxiliary transmission device to transmit motive power through the branch to the front wheels 1, so that the work vehicle is in the four-wheel drive mode, in which the front and rear wheels 1 and 2 are both driven.

Operating the front-wheel power transmission device for two-wheel drive causes the front-wheel power transmission device to block motive power, so that the work vehicle is in the two-wheel drive mode, in which only the rear wheels 2 are driven.

### Lower Lateral Frame Member 21 and Upper Lateral Frame Member 22

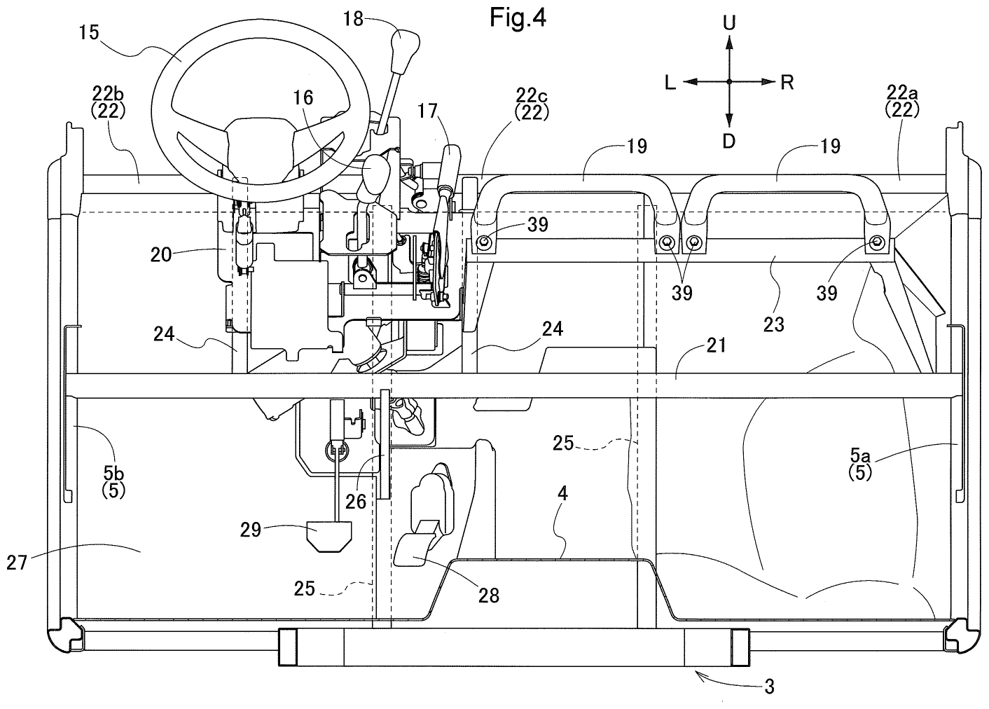

As illustrated in FIGS. 2 and 4, the work vehicle includes a straight lower lateral frame member 21 extending laterally and coupled to respective lower portions of the right and left ROPS frame sections 5a and 5b.

The work vehicle includes an upper lateral frame member 22 including a right section 22a, a left section 22b, and a central section 22c. The right section 22a is coupled to a vertically intermediate portion of the right ROPS frame section 5a and extends therefrom obliquely in a front-left direction in a plan view. The left section 22b is coupled to a vertically intermediate portion of the left ROPS frame section 5b and extends therefrom obliquely in a front-right direction in a plan view.

The central section 22c extends laterally and is coupled to respective front end portions of the right and left sections 22a and 22b. The lower lateral frame member 21 is below the upper lateral frame member 22.

The work vehicle includes a pair of right and left vertical frame members 24 each bent at an angle in a side view and coupled to respective left portions of the lower lateral frame member 21 and the central section 22c of the upper lateral frame member 22. The work vehicle includes an intermediate vertical frame member 23 in the shape of a channel in a plan view and coupled to a lower portion of the right ROPS frame section 5a and the right vertical frame member 24.

The work vehicle includes a pair of right and left vertical frame members 25 coupled to respective right and left portions of the central section 22c of the upper lateral frame member 22 and a front portion of the floor frame 4. The vertical frame members 25 are forward of the ROPS frame 5 and the lower lateral frame member 21 in a side view. The work vehicle includes a longitudinal frame member 26 coupled to a left portion of the lower lateral frame member 21 and a vertically intermediate portion of the left vertical frame member 25.

The work vehicle includes a front panel 27 attached to a front portion of the floor frame 4, the right and left ROPS frame sections 5a and 5b, the upper lateral frame member 22, and the vertical frame members 25. The front panel 27 separates the area of the driver's seat 8 and the passenger's seat 9 from an area forward of the ROPS frame 5.

### Steering Wheel 15 and its Surroundings—1

As illustrated in FIGS. 2 to 4, the work vehicle includes a substrate 20 attached to each vertical frame member 24. The work vehicle includes a steering wheel 15, a shift lever 16, a parking brake lever 17, and a switching lever 18 each attached to the substrate 20.

The steering wheel 15, the shift lever 16, the parking brake lever 17, and the switching lever 18 are attached to each vertical frame member 24 with the substrate 20 in-between, and are positioned forward of the driver's seat 8.

The work vehicle includes a dash panel 14 having two or more openings and positioned forward of the driver's seat 8 and the passenger's seat 9. The steering wheel 15, the shift lever 16, the parking brake lever 17, and the switching lever 18 each extend through the corresponding opening out of the dash panel 14.

The work vehicle includes an accelerator pedal 28 and a brake pedal 29 below a left portion of the dash panel 14. The work vehicle includes two auxiliary handles 19 arranged laterally at a central portion and right portion, respectively, of the dash panel 14 and forward of the passenger's seat 9. The auxiliary handles 19 are coupled to the intermediate vertical frame member 23 and extend backward from the dash panel 14.

### Steering Wheel 15 and its Surroundings—2

As illustrated in FIGS. 1 to 4, the continuously variable transmission device 13 is a belt-based transmission device. Pushing the accelerator pedal 28 increases the number of revolutions of the engine 12, which in turn automatically operates the continuously variable transmission device 13 toward the high-speed side. Letting the accelerator pedal 28 return to its original position decreases the number of revolutions of the engine 12, which in turn automatically operates the continuously variable transmission device 13 toward the low-speed side.

The steering wheel 15 is for use to turn the front wheels 1. The shift lever 16 is for use to operate the auxiliary transmission device in the transmission case for a shift to two forward gears and one rearward gear. The switching lever 18 is for use to operate the front-wheel power transmission device for four-wheel drive or two-wheel drive and to activate and deactivate the rear-wheel differential device.

The work vehicle includes brakes (not illustrated in the drawings) engageable on the front and rear wheels 1 and 2. Pushing the brake pedal 29 activates the brakes. The work vehicle includes a parking brake device (not illustrated in the drawings). Operating the parking brake lever 17 activates the parking brake device and keeps the brakes activated.

### Upper Panel 30

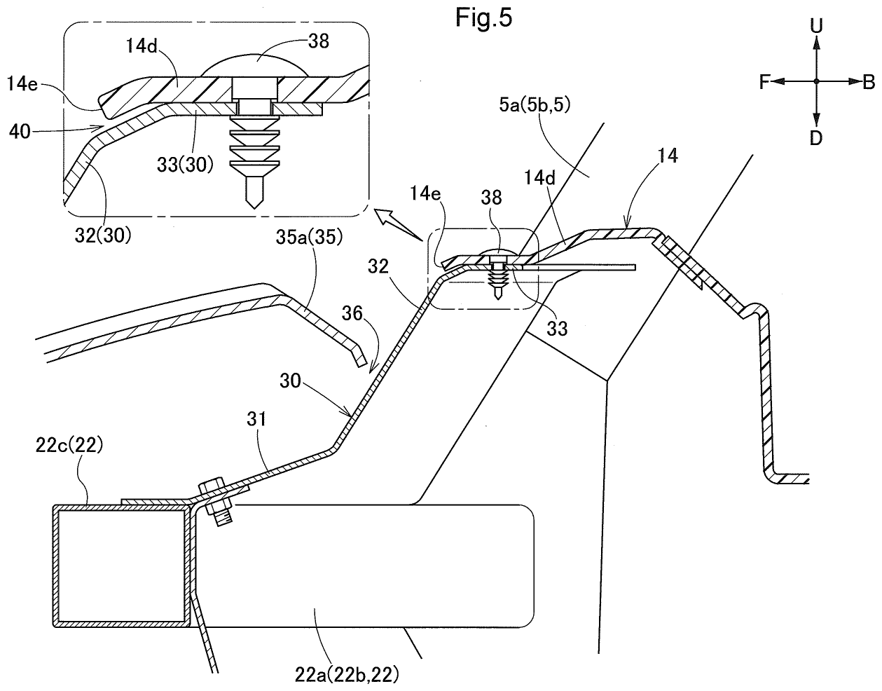

As illustrated in FIGS. 2 and 5, the work vehicle includes an upper panel 30 forward of the dash panel 14. The upper panel 30 is a metal plate so bent as to include a first section 31, a second section 32 (corresponding to the “back portion” of the “upper panel” recited in the claims), and a third section 33 (corresponding to the “back portion” of the “upper panel” recited in the claims). The upper panel 30 extends widthwise from the right ROPS frame section 5a to the left ROPS frame section 5b.

The first section 31 is a flat plate having a front portion coupled to the upper lateral frame member 22 (namely, its right section 22a, left section 22b, and central section 22c) forward of the dash panel 14.

The second section 32 extends from a back portion of the first section 31 obliquely in an upward and backward direction in the shape of a gentle arc in a plan view. The work vehicle includes a pair of right and left brackets 34 coupled to the respective right and left ROPS frame sections 5a and 5b. The second section 32 has a right portion and a left portion bolted to the respective brackets 34.

The third section 33 is a flat plate extending backward from a back portion of the second section 32 in the shape of a gentle arc in a plan view.

As illustrated in FIGS. 1 and 5, the work vehicle includes a hood 35 disposed at an upper front portion of the body 3 and forward of the upper panel 30 in such a manner as to be swingable about a lateral axis D1 to be opened and closed.

The hood 35, in its closed position, has a back end portion 35a above the first and second sections 31 and 32 with a gap 36 between (i) the first and second sections 31 and 32 and (ii) the back end portion 35a and along the entire width of the hood 35.

### Dash Panel 14

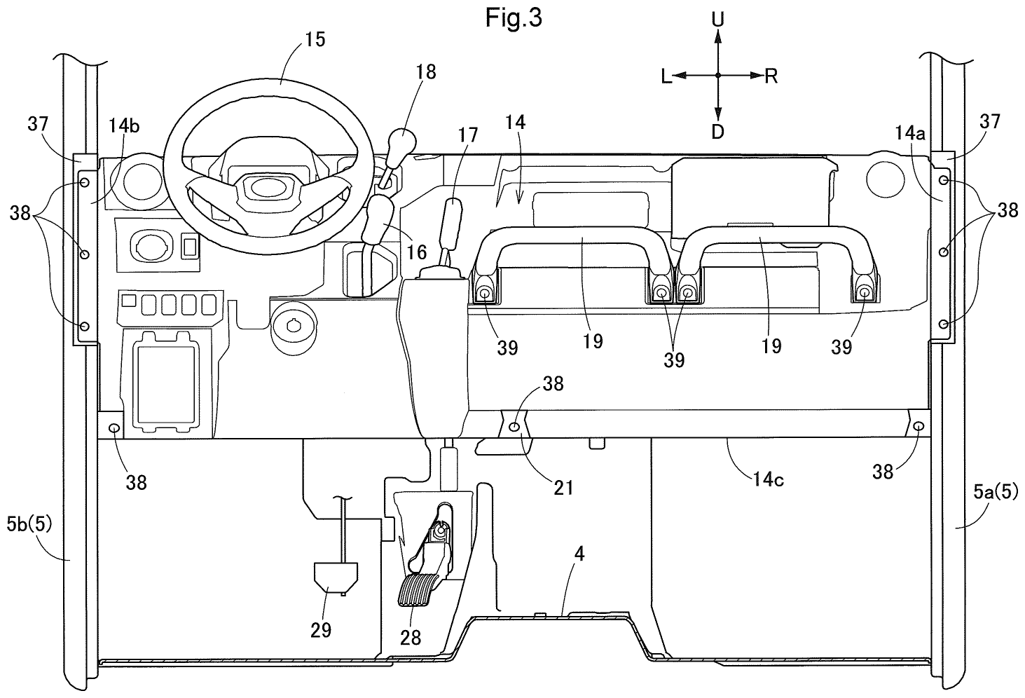

As illustrated in FIGS. 2 and 3, the dash panel 14 is entirely made of synthetic resin, and extends widthwise from the right ROPS frame section 5a to the left ROPS frame section 5b.

The dash panel 14 has a lower portion 14c coupled to the lower lateral frame member 21 with use of pin-shaped couplers 38.

The dash panel 14 is attached to the intermediate vertical frame member 23 from backward (or from outward). The auxiliary handles 19 are attached to a portion of the outer face of the dash panel 14 from backward (or from outward) which portion corresponds to the intermediate vertical frame member 23. The auxiliary handles 19 are each fastened to the intermediate vertical frame member 23 and the dash panel 14 with use of bolts 39 with the dash panel 14 between the intermediate vertical frame member 23 and the auxiliary handles 19.

The work vehicle includes a pair of right and left reinforcement members 37 (see FIG. 1) coupled to respective vertically intermediate portions of the right and left ROPS frame sections 5a and 5b. The dash panel 14 has a right dash panel section 14a coupled to the right reinforcement member 37 with use of couplers 38 and a left dash panel section 14b coupled to the left reinforcement member 37 with use of couplers 38. The right and left dash panel sections 14a and 14b are coupled to the respective right and left ROPS frame sections 5a and 5b with the respective reinforcement members 37 in-between.

As illustrated in FIGS. 2 and 5, the dash panel 14 has a front portion 14d on and above the second and third sections 32 and 33 of the upper panel 30 so that the front portion 14d is over the second and third sections 32 and 33. The front portion 14d extends obliquely in a front-lower direction along the second section 32 in a side (or cross-sectional) view.

The front portion 14d is coupled to the second and third sections 32 and 33 with use of couplers 38 attached to the front portion 14d and the third section 33.

### Gap 40

As illustrated in FIGS. 2 and 5, the front portion 14d of the dash panel 14 is over the second and third sections 32 and 33 of the upper panel 30 with a gap 40 between the front end 14e of the front portion 14d and the couplers 38 (that is, between the front portion 14d and the second section 32) in a side (or cross-sectional) view.

The gap 40 faces forward from the front end 14e in a side (or cross-sectional) view, and extends along the second section 32 to face obliquely in a front-lower direction in a side (or cross-sectional) view. The gap 40 also extends from the right ROPS frame section 5a to the left ROPS frame section 5b along the entire width of each of the dash panel 14 and the upper panel 30 in a plan view.

### First Alternative Embodiment

The gap 40 may alternatively extend partially along the width of each of the dash panel 14 and the upper panel 30.

### Second Alternative Embodiment

The dash panel 14 may have a front portion 14d extending forward and substantially horizontally in a side (or cross-sectional) view.

Since the upper panel 30 includes a second section 32 inclined in a side (or cross-sectional) view, the gap 40 will be vertically larger toward the front end 14e of the front portion 14d of the dash panel 14.

The work vehicle includes:
a body 3;
a travel device (that is, the front and rear wheels 1 and 2) attached to and supporting the body 3;
a driver's seat 8 on the body 3;
a passenger's seat 9 on the body 3 and lateral to the driver's seat 8;
a dash panel 14 disposed forward of the driver's seat 8 and the passenger's seat 9 and having a front portion 14a;
an upper panel 30 disposed forward of the dash panel 14 and having a back portion (that is, the second and third sections 32 and 33); and
a coupler 38 attached to the front portion 14d and the back portion (that is, the second and third sections 32 and 33) and coupling the front portion 14d to the back portion (that is, the second and third sections 32 and 33),
the front portion 14d being over the back portion (that is, the second and third sections 32 and 33) with a gap 4 present between a front end 14e of the front portion 14d and the coupler 38 and facing forward from the front end 14e.

The work vehicle may be configured such that
the dash panel 14 and the upper panel 30 each extend from a right section 5a of the body 3 to a left section 5b of the body 3, and
the gap 4 extends along an entire width of each of the dash panel 14 and the upper panel 30.

The work vehicle may further include:
an upper lateral frame member 22 disposed forward of the dash panel 14, extending laterally, and coupled to a right section 5a of the body 3 and a left section 5b of the body 3,
wherein the upper panel 30 (specifically, its first section 31) is coupled to the upper lateral frame member 22.

The work vehicle may further include:
a lower lateral frame member 21 disposed below the upper lateral frame member 22, extending laterally, and coupled to the right section 5a of the body 3 and the left section 5b of the body 3,
wherein the dash panel 14 has a lower portion 14c coupled to the lower lateral frame member 21.

The work vehicle may be configured such that
the dash panel 14 has a right portion 14a coupled to the right section 5a of the body 3 and a left portion 14b coupled to the left section 5b of the body 3.

The work vehicle may be configured such that
the body 3 includes:
   a floor frame 4 at a lower portion of the body 3; and
   a roll-over protective structure frame 5 coupled to the floor frame 4 and covering the driver's seat 8 and the passenger's seat 9,
the upper lateral frame member 22 and the lower lateral frame member 21 are each coupled to a right section 5a of the roll-over protective structure frame 5 and a left section 5b of the roll-over protective structure frame 5, and
the dash panel 14 has a right portion 14a coupled to the right section 5a of the roll-over protective structure frame 5 and a left portion 14b coupled to the left section 5b of the roll-over protective structure frame 5.

### INDUSTRIAL APPLICABILITY

The present invention is applicable not only to work vehicles including front wheels 1 and rear wheels 2, but also to work vehicles including front wheels 1 and rear crawler travel devices (not illustrated in the drawings) and to work vehicles including a pair of left and right crawler travel devices instead of front and rear wheels 1 and 2.

### REFERENCE SIGNS LIST

1 Front wheel (travel device)
2 Rear wheel (traveling device)
3 Body
4 Floor frame
5 ROPS frame
5a Right section
5b Left section
8 Driver's seat
9 Passenger's seat
14 Dash panel
14a Right portion
14b Left portion
14c Lower portion
14d Front portion
14e Front end
21 Lower lateral frame member
22 Upper lateral frame member
30 Upper panel
32 Second section (back portion)
33 Third section (back portion)
38 Coupler
40 Gap

What is claimed is:

1. A work vehicle, comprising:
a body;
a travel device attached to and supporting the body;
a driver's seat on the body;
a passenger's seat on the body and lateral to the driver's seat;
a dash panel disposed forward of the driver's seat and the passenger's seat and having a front portion;
an upper panel disposed forward of the dash panel and having a back portion; and
a coupler attached to the front portion and the back portion and coupling the front portion to the back portion, and
wherein the front portion is over the back portion with a gap present between a front end of the front portion and the coupler and facing forward from the front end.

2. The work vehicle according to claim 1, wherein:
the dash panel and the upper panel each extend from a right section of the body to a left section of the body, and
the gap extends along an entire width of each of the dash panel and the upper panel.

3. The work vehicle according to claim 1, further comprising:
an upper lateral frame member disposed forward of the dash panel, extending laterally, and coupled to a right section of the body and a left section of the body, and
wherein the upper panel is coupled to the upper lateral frame member.

4. The work vehicle according to claim 3, further comprising:
a lower lateral frame member disposed below the upper lateral frame member, extending laterally, and coupled to the right section of the body and the left section of the body, and
wherein the dash panel has a lower portion coupled to the lower lateral frame member.

5. The work vehicle according to claim 3, wherein:
the dash panel has a right portion coupled to the right section of the body and a left portion coupled to the left section of the body.

6. The work vehicle according to claim 4, wherein:
the body comprises:
a floor frame at a lower portion of the body; and
a roll-over protective structure frame coupled to the floor frame and covering the driver's seat and the passenger's seat,
the upper lateral frame member and the lower lateral frame member are each coupled to a right section of the roll-over protective structure frame and a left section of the roll-over protective structure frame, and
the dash panel has a right portion coupled to the right section of the roll-over protective structure frame and a left portion coupled to the left section of the roll-over protective structure frame.
